(19) United States
(12) Patent Application Publication
(10) Pub. No.: US 2017/0279768 A1
(43) Pub. Date: Sep. 28, 2017

(54) Method and Apparatus for Registering Web Domain Sections

(71) Applicant: Geonetry LLC, Minneapolis, MN (US)

(72) Inventors: Rupinder SINGH, Minneapolis, MN (US); Anup PANDEY, Austin, TX (US); Jeffrey Van MYERS, Driftwood, TX (US)

(73) Assignee: Geonetry LLC, Minneapolis, MN (US)

(21) Appl. No.: 15/283,363

(22) Filed: Oct. 1, 2016

Related U.S. Application Data
(63) Continuation of application No. PCT/US15/23035, filed on Mar. 27, 2015.

(51) Int. Cl. H04L 29/12; H04L 29/08

(52) U.S. Cl. CPC H04L 61/3025; H04L 61/1511; H04L 67/02; H04L 61/2007; H04L 61/609

(57) ABSTRACT

Method and apparatus for converting sections of registered absolute domain names (pages or paths or sub-domains) into marketable assets within a legal, technological and operational framework enabled through a web-hosted system. Within the framework, owners of well-established, reputable domain names having a particular web structure can offer to share with third-party licensees selected sections of the domain that are otherwise unused by the domain owner. The result is an expanded domain that facilitates a variety of monetizable ownership structures, including geographical regionalization of the domain, while exploiting for the mutual benefit of all the established public reputation and search engine ranking of the shared domain.

### CROSS_REFERENCE TO RELATED APPLICATIONS

This application is related to the following Provisional Applications:

1. Ser. No. 61/971,386, filed 27 Mar. 2014 (“First Parent Provisional”);

2. Ser. No. 61/976,167, filed 7 Apr. 2014 (“Second Parent Provisional”); and

3. Ser. No. 61/988,239, filed 4 May 2014 (“Third Parent Provisional”).

This application claims priority to:

1. The First Parent Provisional;

2. The Second Parent Provisional; and

3. The Third Parent Provisional;

collectively, “Related References”, and hereby claims benefit of the filing dates thereof pursuant to 37 CFR §1.78(a)(4).

The subject matter of the Related References, each in its entirety, is expressly incorporated herein by reference.

### BACKGROUND OF THE INVENTION

1. Field of the Invention

The present invention relates to both methods and apparatus for facilitating sharing of ownership of Sections of a single absolute domain name by multiple, independent commercial entities, and an electronic registry of such ownerships.

2. Description of the Related Art

In general, in the descriptions that follow, we will italicize the first occurrence of each special term of art that should be familiar to those of ordinary skill in this art. In addition, when we first introduce a term that we believe to be new or that we will use in a context that we believe to be new, we will bold the term and provide the definition that we intend to apply to that term.

In distributed computer networks, being able to locate individual computers, servers, or various other machines on the network is critical. On the Internet, one of the most valuable identification resources is the domain name. Internet domain names provide a convenient way to reference Internet Protocol (“IP”) numerical addresses. Presently, IP addresses are 32-bit integers. They comprise four numbers separated by periods. Every “host” machine (e.g., computer, etc.) connected to the Internet must be identifiable by a specific numerical IP address. However, people prefer to reference host machines by pronounceable, easily remembered names, referred to as “domain names.” The Internet implements a Domain Name System (“DNS”) to facilitate matching specific domain names to specific hosts.

The DNS is a distributed database system that allows computer applications to map between domain names and IP addresses. The DNS also provides electronic mail routing information and many other services. Individual components of the DNS distributed database can be cached locally, or stored on any of numerous distributed machines. The DNS database data correlates each domain name to a specific numeric IP address. If a computer's local cache does not have the information to resolve a domain name into an IP address, it sends a request to other computers that may contain the resolution information. The DNS affords a domain name some measure of independence from the physical location of a host. The host can be moved to a new location on the network, but it can still be accessed using the same domain name. As long as a user can remember the domain name, the host can always be located, even if the IP address changes over time. This illustrates the value of a domain name that is easy to remember.

Physically, the DNS comprises many servers and other computers or machines that run software and store data permitting computers to query the DNS database. One such machine is the “root server.” A root server is a server computer that maintains the software and data necessary to locate “name servers” that contain authoritative data for a specific domain, such as the “.com” top level domain (“TLD”). Name servers are computers that have the software and data to resolve the domain name into an IP address.

The DNS is organized in a hierarchical, tree structure. A domain name is the label representing a specific domain within the total possible domain space available in the DNS. The highest level in the DNS hierarchy is the “root,” which is technically unnamed but often referred to as the “.” or “dot”. The level immediately below the root in the DNS hierarchy is the TLD because it is the highest level in the hierarchy after the root. The TLD appears furthest to the right in an English-language domain name. For example, “gov” in the “uspto.gov” domain name. There are various types of TLDs.

By registering a domain name in a particular TLD, the TLD is sub-divided into lower levels in the DNS hierarchy. A second-level domain (“SLD”) is the level in the DNS hierarchy immediately below the TLD. An example of an SLD would be “semiprecious” in the “semiprecious.com” domain name. The level in the DNS hierarchy immediately below the second-level domain is the third-level domain. An example of the third-level domain would be “portland” in the “portland.or.us” domain name. Further subdivisions can be created in a similar manner. Domain names at each level of the hierarchy must be unique. Thus, while there can be only one “semiprecious” registered in the “.com” TLD, there can be a “semiprecious.net” domain name in addition to the “semiprecious.com” domain name.

A fully qualified domain name (“FQDN”), sometimes also referred to as an absolute domain name, is a domain name that specifies its exact location in the tree hierarchy of the DNS. It specifies all domain levels, including the TLD and the root zone. A FQDN is distinguished by its lack of ambiguity: it can be interpreted only in one way.

Historically, domain name registration has been conducted through a Shared Registration System (“SRS”) involving registries, registrars, and registrants. The SRS was created by Network Solutions, Inc. in 1999 to provide a registry backend through which multiple, globally diverse registrars could register domain names.

In general, the ad hoc development of the Internet has resulted in a number of problems that are becoming increasingly problematic:
1. Monopolization of search engines by big companies with mammoth resources. One result is that small businesses are increasingly disappearing from top search rankings.
2. Scarcity of good quality domain names. One result is that new entities are forced to use longer Universal Resource Locators (“URLs”) which are more difficult for potential customers to remember and enter correctly. One other development related to this problem is the recent expansion by the World Wide Web Consortium of the number of top level domains (“TLDs”).
3. Under-utilization of established website assets. One result is that many high profile domain names are relatively dormant, i.e., are not being used effectively.
4. Both new and existing sites seeking growth in search traffic (organic or paid) must invest considerable sums of money and effort across multiple media channels. Typically, results are not always certain and usually take too long. Thus, advertising to get productive traffic tends to be a continuous money sink.

As of today, the concept of selling or leasing discrete Sections, e.g., pages or paths or sub-domains or geographical region, of a FQDN does not appear to have been proposed. We submit that all existing systems fail to exploit the potential value of a website by creating an effective market for one or more Sections of that FQDN in a streamlined way under a legal, technology and operational framework that establishes a formal structure to control delivery of content to respective Sections of the FQDN.

We are aware of no precedence to match our invention exactly. What is needed, we submit, is a system for sharing website Sections that improves the way Tenants work with Owners. Such a system can create an entirely new partnership model between Tenants and Owners. This system would also facilitate efficient monetization of existing, great domain names that are presently under-exploited, and by expanding the revenue potential of existing, established domain names using a variety of different content delivery and control structures.

### BRIEF SUMMARY OF THE INVENTION

In one embodiment of our invention, we provide a method for displaying information on the availability for reservation by a user of a section of a fully qualified domain name, wherein each section comprises a respective domain name combined with one of a plurality of domain name modifiers. In accordance with our method, we first display a query results table showing, for each of multiple names specified by the user, the availability of respective sections for reservation; and then, for each of the sections available for registration, providing a selection mechanism within the query results table to permit the user simultaneously to select a plurality of available sections for reservation.

In one other embodiment of our invention, we provide a method of registering sections of a fully qualified domain name, wherein each section comprises a respective domain name combined with one of a plurality of domain name modifiers. In accordance with our method, we provide: a section registration process adapted to create and maintain a section register; a listing process adapted to allow an owner of the domain name to list in the section register a section of the domain name available for tenantship; a reservation process adapted to allow a prospective tenant to reserve in the section register a selected listed section; a registration process adapted to allow the owner to register in the section register a tenantship to the reserved section for the benefit of the tenant; and a content delivery process adapted to allow the tenant to source content for the registered section.

### BRIEF DESCRIPTION OF THE SEVERAL VIEWS OF THE DRAWINGS

Our invention may be more fully understood by a description of certain preferred embodiments in conjunction with the attached drawings in which:

FIG. 1 illustrates an Internet-implemented system including a Browser and a Master Server, according to one embodiment of our invention;

FIG. 2 illustrates our Content Delivery Service according to one embodiment of our invention;

FIG. 3 illustrates, in block diagram form, the process for checking availability of and selecting multiple Sections for registration;

FIG. 4, comprising FIG. 4a and FIG. 4b, illustrates two alternative examples of a web page for checking availability of a selected set of Sections;

FIG. 5 illustrates the steps performed by the Leasing Service to process an availability query;

FIG. 6, comprising FIG. 6a, FIG. 6b and FIG. 6c, illustrates, by way of example, a web page showing a typical Availability Results Table at selected points in our Leasing Service;

FIG. 7 illustrates, by way of example, a web page showing a typical Section Reservation Table;

FIG. 8 illustrates the steps performed by our Listing Service if a query submitted to our Leasing Service includes an unlisted domain name;

FIG. 9 illustrates, in flow diagram form, one possible instantiation of our Content Delivery Service as illustrated in FIG. 2;

FIG. 10 illustrates, in flow diagram form, one alternate instantiation of our Content Delivery Service as illustrated in FIG. 2.

FIG. 11 illustrates, by way of example, a typical distribution of Sections of a shared FQDN, e.g., cars.com, based on geographical regions; and

FIG. 12 illustrates, in flow diagram form, one possible instantiation of our Content Delivery Service adapted to support geographically distributed Sections as illustrated in FIG. 11.

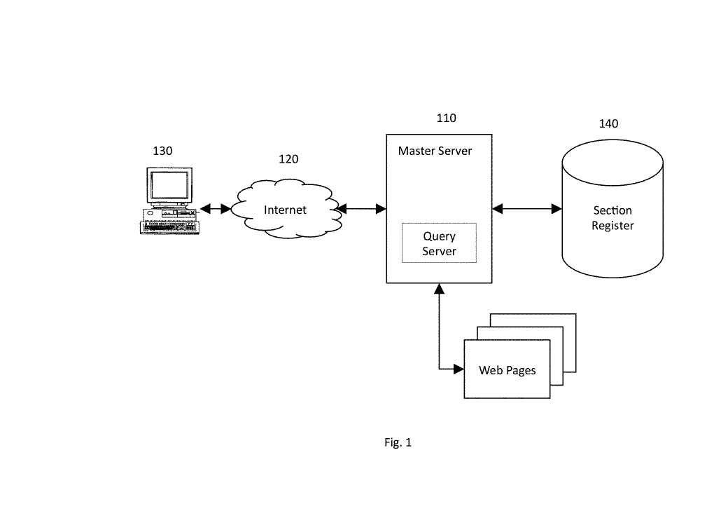

In the drawings, similar elements will be similarly numbered whenever possible. However, this practice is simply for convenience of reference and to avoid unnecessary proliferation of numbers, and is not intended to imply or suggest that our invention requires identity in either function or structure in the several embodiments.

### DETAILED DESCRIPTION OF THE INVENTION

We submit that a completely new way of thinking about absolute domain name “real estate” is needed in order to unlock hidden value in a way that facilitates expansion of traffic, reduces costs and helps small businesses, all at the same time. For convenience and consistency of reference, in the following, we shall refer to the following:
Registrar: the DNS registrar of a specific domain name;
Owner: the actual registered owner of a specific domain name;
Users: ordinary users, e.g., customers seeking products or services;
Prospect: a User that desires to become a Tenant;
Tenant: a Prospect that has established a Tenantship to a Section;
Browser: the facility used by Owners, Prospects, Tenants, and users to access the Internet, including the actual browser software package;
Encumbrance: a legal encumbrance granted with respect to a Section (i.e., an inherently intangible asset) by an Owner to a Tenant that restricts, in time, in scope or both, the available actions of the Owner for the benefit of the Tenant—notwithstanding that traditional encumbrances relate only to real property assets, our Encumbrances are explicitly adapted (as explained below) to resemble, by analogy, a sale, a lease or other arrangement relating to real property established under the law of the jurisdiction;
Tenantship: the relationship established by an Encumbrance between an Owner and a Tenant;
Tenant Server: the Tenant server(s) that deliver Tenant-specific content;
Host: our Section management system;
Master Server: the web-based servers that implement our Section management system;
Section Registry: the Master Server database that records Sections, the Owners thereof, and any registered Tenantships;
Listing Service: the Master Server process that enables Owners to list Sections for Encumbrance;
Leasing Service: the Master Server process that enables Prospects to review selected Sections registered by the Owners thereof as available for Encumbrance, and to establish Tenantship of selected Sections; and
Content Delivery Service: the Master Server process that enables Tenant Servers to source content for Sections under Tenantship.

As will be discussed in greater detail below, we have invented a method and apparatus whereby a website Section, i.e., a path or page or sub-domain, may be listed by the Owner in an electronic Section Registry hosted on our Master Server. Using a Browser interface, a Prospect may submit a query to our Master Server to determine the availability of selected Sections for Encumbrance. After the query results are returned for each of the Sections of interest, the Prospect is presented with a table listing the availability of each Section. The Prospect is may request reservation of one or more of the Sections in our Section Registry. After the Master Server has attempted to reserve each of the selected Sections, the Prospect is presented with a tabular response indicating which of the selected Sections were successfully reserved to the Prospect. Within an agreed period of time after a Section has been reserved, the Prospect and Owner must negotiate and execute a mutually agreeable Encumbrance Agreement; if no such Encumbrance Agreement is timely executed, the reservation of the Section is released. Thus, our method and apparatus provide a user-friendly mechanism for querying, reserving and establishing Tenantship of all registered Sections, thus enabling trading and monetization of Sections.

### Overview

Our system includes one or more Master Servers adapted to maintain a Section Registry of available Sections, to generate and display real-time data tables indicating the availability of Sections in the Section Registry, and to register Tenantship of listed Sections in the Section Registry. In one embodiment, the Master Server provides a set of Services adapted to provide an easy-to-use interface between our Section Register, our Owners, our Tenants, Prospects and Users.

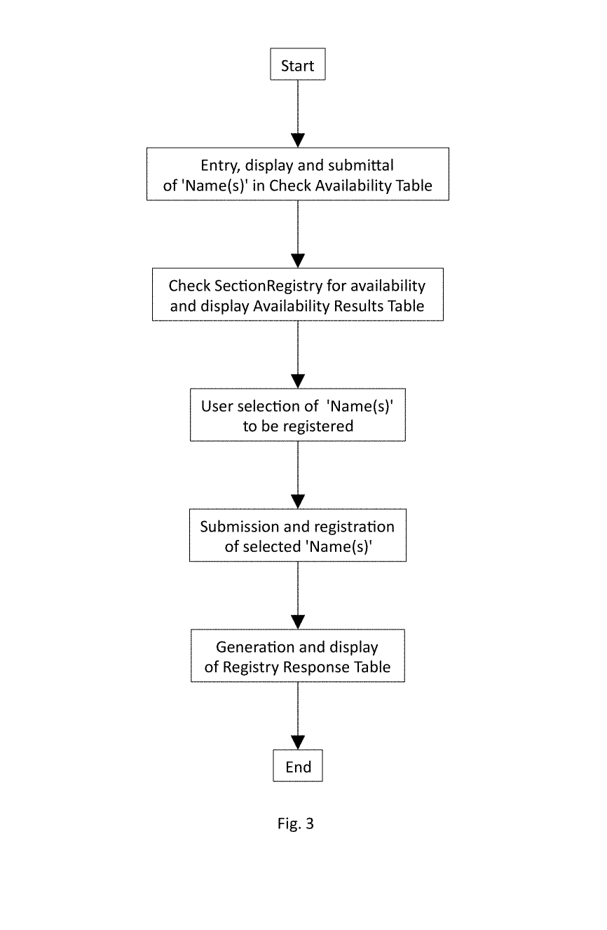

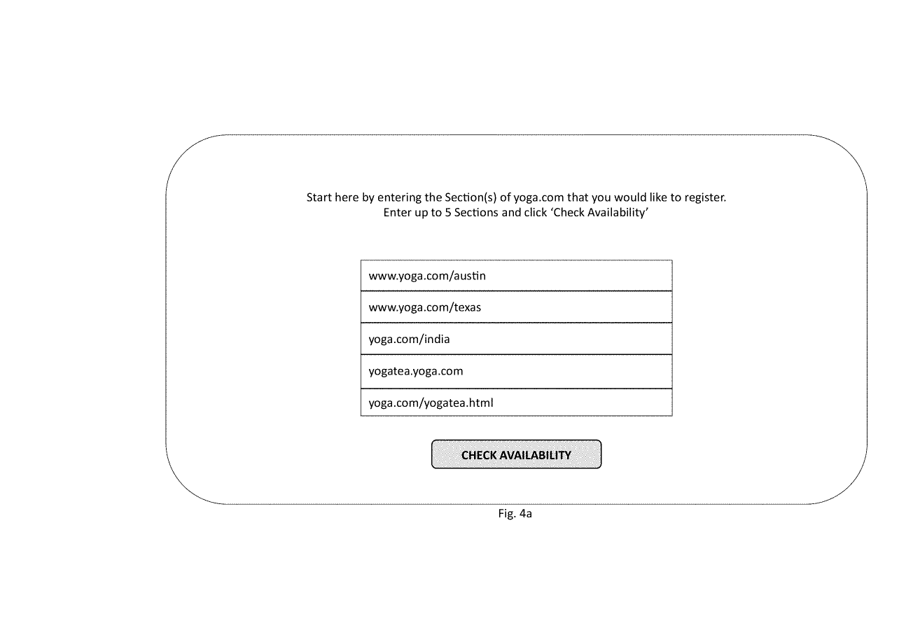

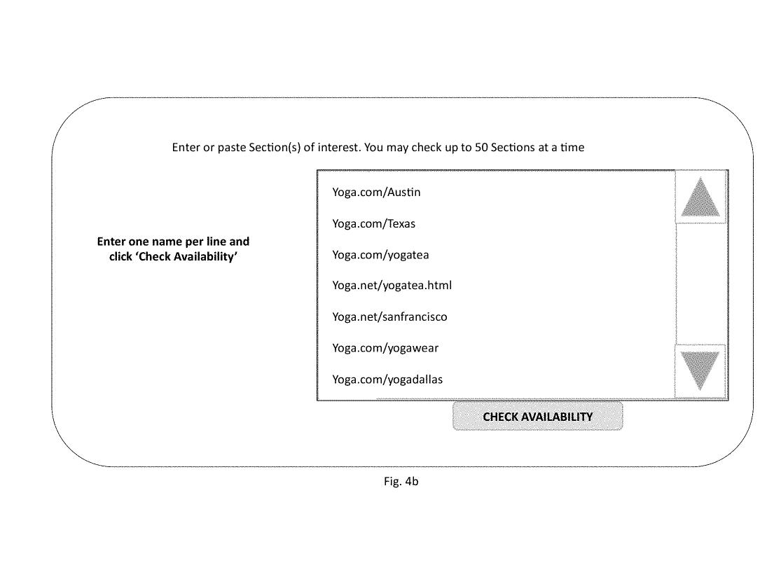

Our Leasing Service is invoked when a Prospect submits an Availability Request Query (“ARQ”) to determine the availability of one or more Sections for registration in the Section Registry. In FIG. 3, we have illustrated a typical process flow for checking Section availability. The Section may, but need not, include TLD extensions. In the ARQ, the Prospect specifies the Section using a display screen or view, which may be a web page or another screen or view produced by proprietary software. In another embodiment, the Section may be specified using voice recognition software. By allowing the Prospect simultaneously to submit single or multiple Sections, our Leasing Service reduces the amount of time required to check the availability of multiple Sections. In one embodiment, illustrated by way of example in FIG. 4a, the ARQ comprises a set of text fields into which the Prospect types the set of Sections In another embodiment, illustrated by way of example in FIG. 4b, the ARQ comprises a scrollable window that allows the Prospect to enter a large number of Sections in a more efficient manner.

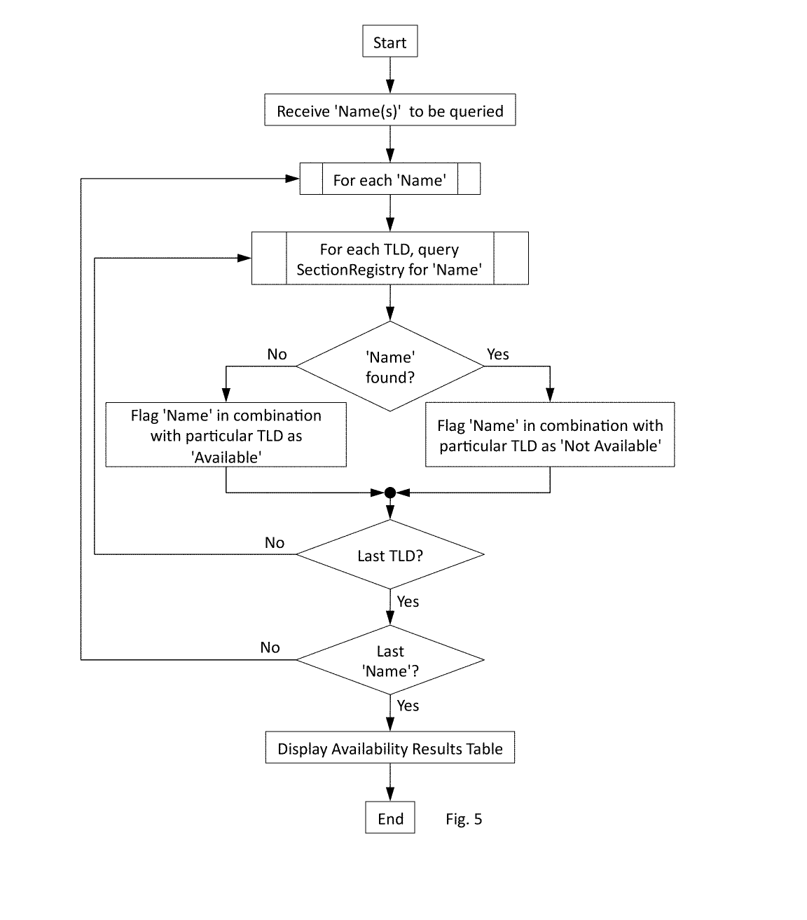

As illustrated in FIG. 5, our Leasing Service is adapted to search the Section Registry for each Section in the submitted ARQ. In one embodiment, each Section is queried in combination with all possible TLD extensions without requiring the Prospect to specify any specific TLD extension(s). In another embodiment, the Prospect may specify TLD extensions of the Section to be used when querying the Section Registry. The Leasing Service may automatically supplement the TLD extensions specified by the Prospect with “related” TLD extensions of the Section; for example, if the Prospect submits “abc.com/austin”, the Leasing Service may automatically check the availability of both “abc.com/austin” and “abc.net/austin”.

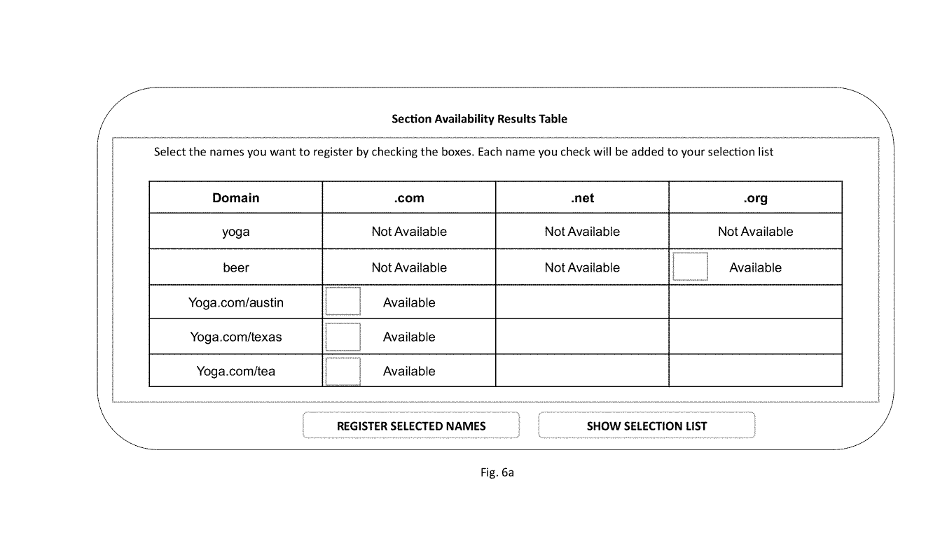

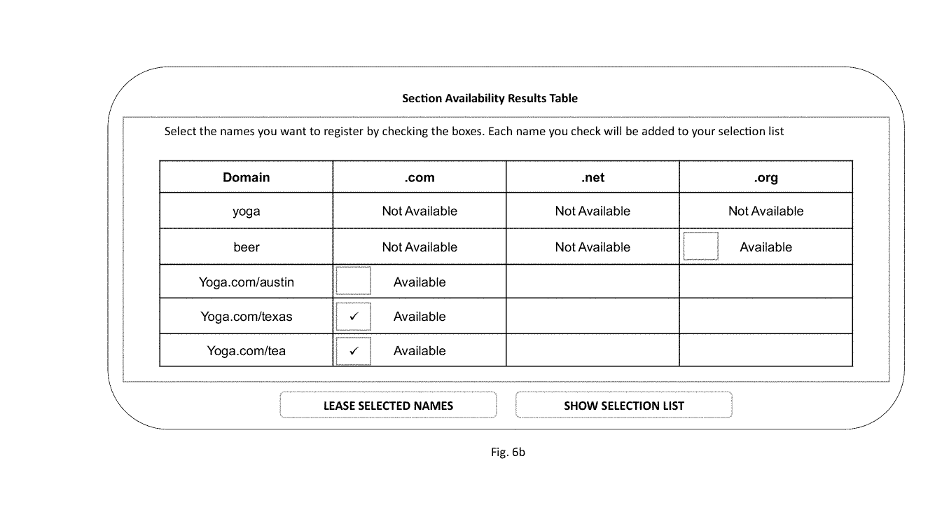

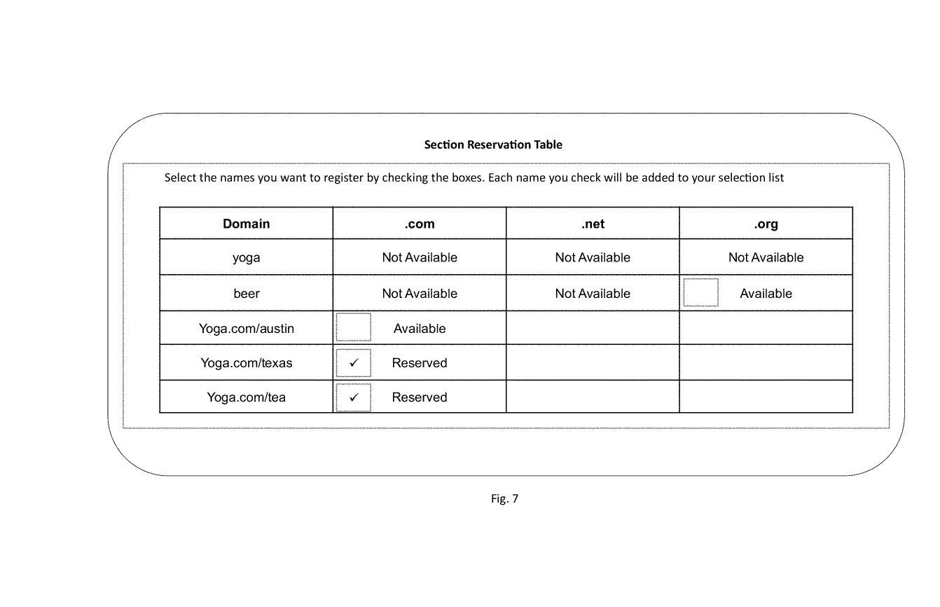

After the Section Registry has been queried for each of the Sections submitted, the Prospect is presented with an Availability Results Table (“ART”), as illustrated in FIG. 6a, showing the availability of each Section in conjunction with each TLD extension of each Section; preferably, the ART includes a selection mechanism, such as the illustrated check boxes, associated with each available Section (name-TLD pair) whereby the user may select one or more Sections for registration. After selecting one or more Sections for registration (FIG. 6b) and confirming the Sections selected, the Prospect can initiate a request that the selected Section(s) be reserved pending completion of the leasing transaction. After the Leasing Service has reserved the Sections selected, the ART is updated to indicate which Sections were successfully reserved. In one embodiment, as illustrated in FIG. 7, our Section Reservation Table (“SRT”) allows the Prospect to modify the reserved set of Sections by selecting a different combination of available/reserved Sections and re-submitting the request.

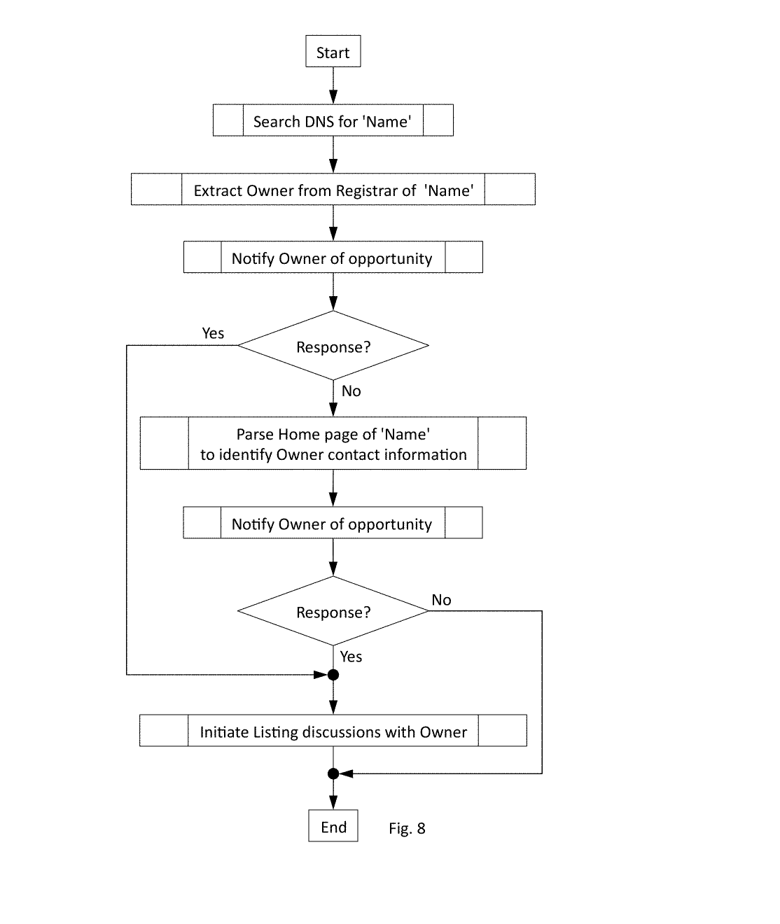

In the event that the Prospect submits a domain name that is not listed in our Section Register, our Leasing Service may, in one embodiment, inform our Solicitation Service of the unlisted domain name. In response, as illustrated in FIG. 8, our Solicitation Service will electronically search the DNS for the Registrar of the domain, and, when found, extract the ownership records. If, a predetermined time period after notifying the registered owner of the opportunity to list the domain in our Section Register, we have received no response, our Solicitation Service will electronically access the “Home” (or, perhaps, the “Contact Us”) page of that domain, e.g., using the utility cURL, and parse the retrieved content to identify email links to the domain's webmaster (or other designated contacts). If we again unsuccessful in notifying the owner of the opportunity to list the domain in our Section Register, we will cease our efforts; however, if successful, our Solicitation Service will initiate an internal action to have our staff open listing discussions with the owner. Since this process may take several days (or possibly longer), our Leasing Service may, optionally, put the Prospect on notice of the possibility of the queried domain Section becoming available in the future by designating the respective table entry in the ART as “Pending”, or the like.

### The Major Frameworks

A Legal Framework through which Sections of a website become a tradable product. This legal framework and the process of commercialization of Sections is enabled through a web based system. The legal framework will include but is not limited to the following attributes: (a) Tenantship of Sections; (b) transfers of control of Sections; (c) respective Owner/Tenant rights to Sections; (d) registration of Sections; (e) type of content and transactions allowed/not allowed on Sections; (f) rights to continued use of domain name hosting the Sections; (g) usage guidelines for Sections; (h) state and federal compliance; (i) Tenantship guidelines on hosting, e-commerce technology, prohibited applications; (j) dispute resolution; (k) certificates of Tenantship for Sections; (l) legal process if domain name expires or if the Owner folds or if the Owner is not in compliance with state and federal laws regarding tax, fraud, etc.; (m) liability; (n) taxation; (o) external links and advertisements; (p) security of transactions; and (q) clear delineation of rights between the Owner and all Tenants with respect to Sections of a FQDN. The attributes of the legal framework and the Encumbrance Agreement(s) with the trading partners is enabled through our web based system.

The Legal Framework consists of a one or more Encumbrance Agreement(s), valid under the laws of the jurisdiction in which the Master Server is sited (“Host Jurisdiction”), that define the respective rights and obligations of the Master Server provider, the Owners and the Tenants. In many jurisdictions, the Encumbrance established by the Legal Framework can be modeled either as a sale or as a lease; in some jurisdictions, however, a novel relationship may be necessary to conform with nuances of the local legal system.

Condominium Sale Model:
1a. The Host establishes a Section Tenants Association (by analogy, similar to a physical Condominium Owners Association), and adopts Bylaws that clearly define the mutual rights and obligations of the Host, the Owners and the Tenants. The organizational documents, including the Bylaws may be recorded with local authorities, and may, if desired, made available for public viewing. Of particular importance in these types of organization are the provisions in the Bylaws for dispute resolution, both between the Host and the Owners, between the Owners and their Tenants; and between Tenants sharing different Sections of the same domain. Numerous sources are available for Model Condominium organization documents; modifications may be made to better suit the nature of these particular assets and the legal system of the Host Jurisdiction. However, by analogy, these organizational forms appear to be appropriate in this business model.
1b. Sections are offered for sale on clear and well define terms, including up-front payments, periodic payments, qualification and closure requirements, etc. A web interface is adapted to allow a Prospect to enter all pertinent detailed information and to receive an estimate of the sale price. Pricing should include several factors: the relative success to date of the Host's services; the tier of the requested Section, e.g., sub-domain (top tier price), path (mid-tier price) or page (bottom-tier price); the base (i.e., normal maximum) traffic anticipated/desired by the Prospect; periodic (e.g., monthly) cost-of-services (similar to minimum utilities services in a physical structure); and the like. In particular, the Prospect should be made aware of any “overage” charges that may be imposed as a result of traffic exceeding the base traffic levels; at this point in time, it is advisable to inform the Prospect of future opportunities to subscribe to higher (or, perhaps, lower) levels of traffic support at fixed rates less than the overage rates. One other disclosure that should be made is the right of the Host to periodically (e.g., annually, bi-annually, etc.) increase fees for the variable services (as in the case of utility rate increases in a physical structure); one option would be to limit the Host's right to increase such fees to a maximum percentage per period, e.g., no more than 15% per 2-year period.

1c. Once sold to a Prospect, now Tenant, the “sold” Section(s) becomes the sole and exclusive property of the Tenant, with full rights to re-convey, encumber, etc., as in the cases of real or personal property in the Host Jurisdiction; subject, of course, to restrictions set forth in the Bylaws.

1d. Although this Condominium Sale Model may be perceived more favorably by Prospects, this model has one inherent characteristic that renders it particularly problematic: how to deal with a Tenant who simple refuses to abide by the Bylaws. Since a sale is considered in most jurisdictions to be final and irrevocable, it becomes difficult, if not impossible, to recover the asset from the Tenant. One solution might be to establish a “termination of services” procedure in the Bylaws, pursuant to which a recidivist Tenant, upon written concurrence of a stated majority of the other Tenants (and with the written consent of the Host), will be denied service by the Host's server at a fixed point in time, and, in the interim, the Host's server will be configured to re-direct all traffic to a server of the Tenant's choice (or if the Tenant refuses to so choose, to a default page informing the requesting Browser that the requested content is no longer available). However, in conformance with the general concepts of a sale, upon any such compulsory termination, the Tenant's Section(s) become “vacant” and must never be offered for sale to any other interested entity. Perhaps, a process, with appropriate penalties, may be included in the Bylaws by which, for a defined period of time, the terminated Tenant may rehabilitate themselves and restore normal Host services.

Apartment Lease Model:

1A. The Host establishes an Encumbrance Agreement that clearly defines the mutual rights and obligations of the Host, the Owner and the Tenant. The Encumbrance normally need not be recorded with local authorities, but a generic draft of the Encumbrance may, if desired, be made available for public viewing. Of particular importance in an Encumbrance are the provisions for dispute resolution between the Host and the Tenants (disputes between a Tenant and an Owner or between Tenants are subject to resolution by the Host). Numerous sources are available for model lease documents; modifications may be made to better suit the nature of these particular assets and the legal system of the Host Jurisdiction. However, by analogy, these organizational forms also appear to be appropriate in this business model.

1B. Sections are offered for lease on clear and well define terms, including up-front payments, periodic Section lease payments, qualification and closure requirements, etc. A web interface is adapted to allow a Prospect to enter all pertinent detailed information and to receive an estimate of the lease price. Pricing should include several factors: the relative success to date of the Host's services; the tier of the requested Section, e.g., sub-domain (top tier price), path (mid-tier price) or page (bottom-tier price); the base (i.e., normal maximum) traffic anticipated/desired by the interested entity; periodic (e.g., monthly) cost-of-services (similar to minimum utilities services in a physical structure); and the like. In particular, the Prospect should be made aware of any “overage” charges that may be imposed as a result of traffic exceeding the base traffic levels; at this point in time, it is advisable to inform the Prospect of future opportunities to subscribe to higher (or, perhaps, lower) levels of traffic support at fixed rates less than the overage rates. One other disclosure that should be made is the right of the Host to periodically (e.g., annually, bi-annually, etc.) increase fees for both the base lease as well as the variable services (as in the case of utility rate increases in a physical structure); one option would be to limit the Host's right to increase such fees to a maximum percentage per period, e.g., no more than 15% per 2-year period. One set of provisions unique to a lease model are the terms and conditions under which the Tenant may renew the Encumbrance.

1C. Once leased to a Tenant, the encumbered Section(s) becomes the temporary property of the Tenant, with no rights to convey, sub-let, encumber, etc., as in the case of real property in the Host Jurisdiction; subject, of course, to restrictions set forth in the Encumbrance.

1D. Although this Apartment Lease Model may be perceived less favorably by Prospects, this model has one inherent characteristic that renders it particularly attractive to the Host: it is easy to deal with a Tenant who simple refuses to abide by the Encumbrance. Since a lease is considered in most jurisdictions to be revocable according to its terms, it becomes (relatively) easy to recover the assets from the Tenant. In particular, the Host should include a “termination of lease” procedure in the Encumbrance, pursuant to which a Tenant, upon the occurrence of one or more stated events (without timely, appropriate remedial action) will be denied access to the Host's server at a fixed point in time, which could be immediately upon notice. To make such a termination right more acceptable to Prospects, the Encumbrance may provide that, during a defined transition period, the Host's server will be configured to re-direct all traffic to a server of the Tenant's choice (or if the Tenant refuses to so choose, to a default page informing the requesting Browser that the requested content is no longer available). However, in conformance with the general concepts of a lease, upon any such compulsory termination, the Tenant's Section(s) do NOT become dormant and may be immediately offered for lease to other interested entities. Perhaps, a process, with appropriate penalties, may be included in the Lease by which, for a defined “probationary” or “cooling off” period of time PRIOR to actual termination, the Tenant threatened by the Host with imminent termination may rehabilitate themselves and restore normal Host services.

In either the Condominium Sale Model or the Apartment Lease Model (or any other model), it is essential, from a legal perspective, that the Owner be required to modify the Domain Registration maintained by the Registrar of the domain name so as to transfer control of the listed domain to the Host. Of course, the Listing Agreement(s) must deny the Host the ability and power to further transfer control to any third party without the expressed consent of the Owner. Within this constraint, the Host will have exclusive authority and power to preserve the Domain Registration by timely paying renewal fees to the Registrar, and to otherwise protect the Domain Registration for the mutual benefit of the Owner and all Tenants. The Listing Agreement may also provide for termination of the agreement in the event that no Tenantships have been established prior to the request for termination. In instances where only lease-type Encumbrances are authorized by the Owner, the Listing Agreement may provide for staged termination at the request of the Owner, with existing Tenantships being released in accordance with terms agreed by the Tenant at the time the Encumbrance was established.

An Operational Framework through which Sections (pages or paths or sub-domains) of the website become a tradable product. This operational framework and the process of commercialization of parts of website is enabled through a web based system. The operational framework will include but is not limited to the following attributes: (a) policy on external links; (b) policy on Google AdSense/external ads; (c) branding guidelines; (d) content guidelines; (e) analytical tools; (f) insurance products; (g) a variety of business management tools; (h) website downtime; and (i) content served for Sections based on User geographical location and type of device (e.g., desktop, laptops, tablets, smartphones, etc.) being used. The attributes of the operational framework and the operational agreements/contracts with the trading partners is enabled through our web based system.

Our Operational Framework implements the Section Registry. Just as a domain name registrar maintains a registry of domain names, our Section Registry database will maintain a global registry of all Sections bought, sold or leased. Thus, Prospects can search for availability of a particular Section just as they search today for availability of domain names. Our Section Registry:
1. represents an online platform for trading and managing ownership/leasing of Sections;
2. facilitates the purchase, sale or lease of Sections; and
3. provides proof of ownership or control of Sections.

Our Section Registry will, for each registered Section, store the name and contact information of the domain Owner and, if leased, the Tenant. Our Register also manages the contract between the parent domain owner and the Section owner/lessee. Our Register will also maintain a detailed history of every transaction that for registered Sections. If the site owner has not marked the records as “private”, the Register is capable of displaying the full ownership pyramid of the domain to any one searching for the current ownership structure of the parent domain. Thus, the Register may perform as a search tool that appears to the general public like the WHOIS database search for domain names.

Note: registry database noted above may be implemented using any of a number of available database servers, e.g., SQL, MySQL, ORACLE, dBase, etc. The core of the host server may be implemented using any of several available web servers, e.g., Microsoft IIS, Apache, etc.

Because our system is preferably implemented using an object-oriented extensible programming model (such as Java), it is possible for a virtually unlimited number of specified or system-generated Sections to be processed for availability analysis, reporting, selection, Section registration, and registration confirmation at one time. In one web-based embodiment, the Availability Results and Registry Response Tables are dynamically created as Java Server Pages (“JSPs”).

A Technological Framework through which Sections become a tradable product. This technological framework and the process of commercialization of Sections is enabled through a web based system. The technological framework will include but is not limited to the following capabilities: (a) trading of Sections; (b) database to manage registrations and Tenantships; (c) search tools; (d) verify website Section ownership/availability; (e) Section financial value estimation tools for buying/selling/leasing; (f) CRM; (g) shopping cart; and (h) content management.

### The System Facilities

In general, our Section registration and management system includes the following essential support facilities:

A software algorithm tool to ascribe financial value to different Sections of any website. The software tool will include but is not limited to below metrics in ascribing financial value to Sections of a website: (a) Unique user traffic (daily/weekly/monthly unique count of visitors coming to the Section); (b) % new visits; (c) average time on site; (d) bounce rate; (e) days and visits to purchase; (f) repeat traffic/loyalty; (g) industry vertical; (h) traffic sources (e.g., search—organic, direct, affiliates); (i) demographics; (j) brand recognition of the domain name; and (k) size of human populations within a particular geographical region when leasing domain names by geography (examples are services related domain names like yoga.com, salon.com, tailr.com, etc.). This data may be made developed from standard click-stream tools like Google Analytics, web-trends and/or qualitative surveys. Other tools include but are not limited to: email management, Section management, landing pages and other e-commerce functions.

Section Valuation: Our system also implements a tool, e.g., using Google Analytics or other independent websites like ‘compete’ or ‘hit-wise’, to acquire information specific to a FQDN to estimate a dollar value for Sections of that FQDN:
a. Unique user traffic;
b. Bounce rate;
c. Loyalty metrics like repeat visits, days and weeks between visits;
d. Average time on site;
e. % new visits;
f. Sources of traffic (search driven, affiliates or direct);
g. Search rankings of the page; and
h. Human population within particular geographical regions.
   In addition to the above available data, this tool will also list out potential categories. e.g., machinery, gemstones, consumer goods, and will also break these categories into sub-groups which have common demographics and purchasing behavior. For example, gemstones will be sub-divided into semiprecious and precious and if ‘X visits/day’ go both to a precious and a semiprecious Section, a higher value is given to the visits going to the precious Section basis higher dollar amount of purchase in a single transaction.

Traffic Valuation: Our traffic valuation tool will provide a comprehensive list of categories which will be segmented into appropriate sub-groups for valuing website traffic. The traffic value will also be discerned looking at the paid-per-click dollar value of the traffic in common ad platforms like Google, Facebook, Amazon, etc. Our tool will also provide an option to manually determine the value of the Section as a service offer to capture the uniqueness of that Section. The resulting valuation of a particular Section may form the base value (both for selling and for leasing) of the particular Section of the website. Our automated tool will also provide reporting metrics on an ongoing basis to highlight the key business outcomes in a measurable way to facilitate understanding of the impact of the Section which have been leased or sold to the original domain and vice versa. For example, if the current baseline unique traffic visits was ‘x/day’, the tool will measure the performance to this baseline to evaluate how additional content in different Sections is impacting overall traffic and other key business outcomes for the overall domain and for selected Sections. Using our traffic valuation tool, potential customers can browse selections of website Sections which are available for sale/lease by searching by one or more criteria: by industry, keywords or by key metrics (traffic count, % new visits, bounce rate, repeat traffic/loyalty, demographics, population within a given geographical region, etc.).

### Content Control of Sections

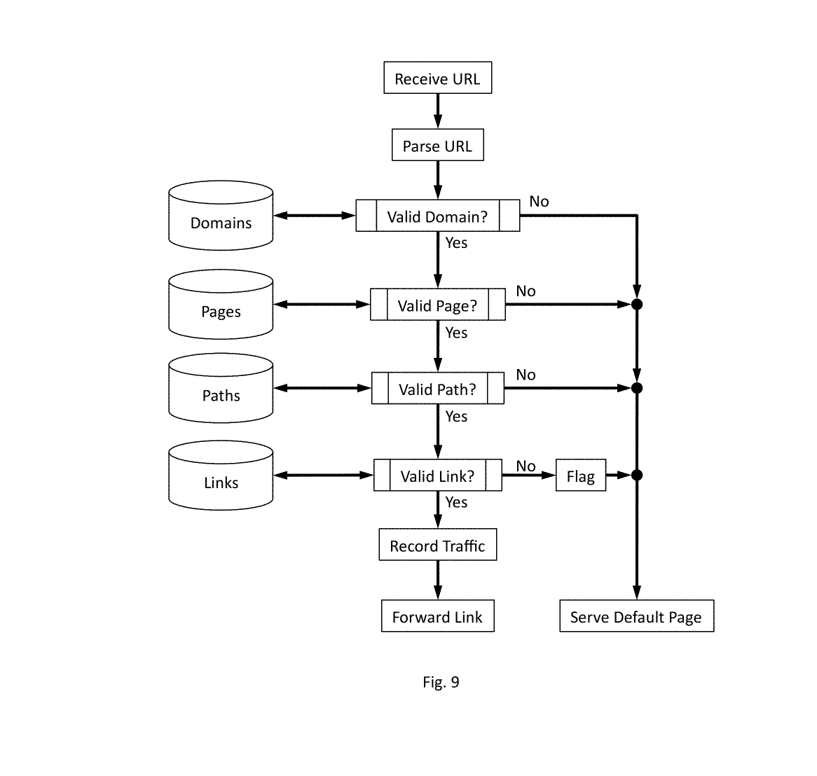

Request linked via Master Server: Illustrated in FIG. 9 is one approach to facilitating delivery of content from a Tenant Server is to maintain a database of links in our Master Server, each adapted to fetch the content for the requested page from the Tenant Server(s). In this embodiment, ALL of the specific pages (/gems, /pears, /beads) are hosted in the Tenant Servers belonging to different Tenants. To the Browsers, these pages are displayed under the original domain name (in this case semiprecious.com) and the page is displayed as semiprecious.com/pearl (or beads, or gems). In this approach, the page is always linked to the original domain but gets all new content from the respective Tenant Servers. Both original and the page under one domain get quid pro quo search benefits: the page (/pearls, /beads, /gems) gets it because it is linked to semiprecious.com; and the original domain gets it from vested Tenants helping its search ranking. One serious problem with this approach is that the Master Server has no visibility of the content delivered by the Tenant Server(s), since that content is generally automatically forwarded “as is”. Although known server plug-ins are available for filtering (actually, rewriting) the content, it is not generally considered safe to rely on such tools due to the large number of ways that undesirable content, e.g., malware, pornography, offensive content and the like, may be embedded in the delivered content.

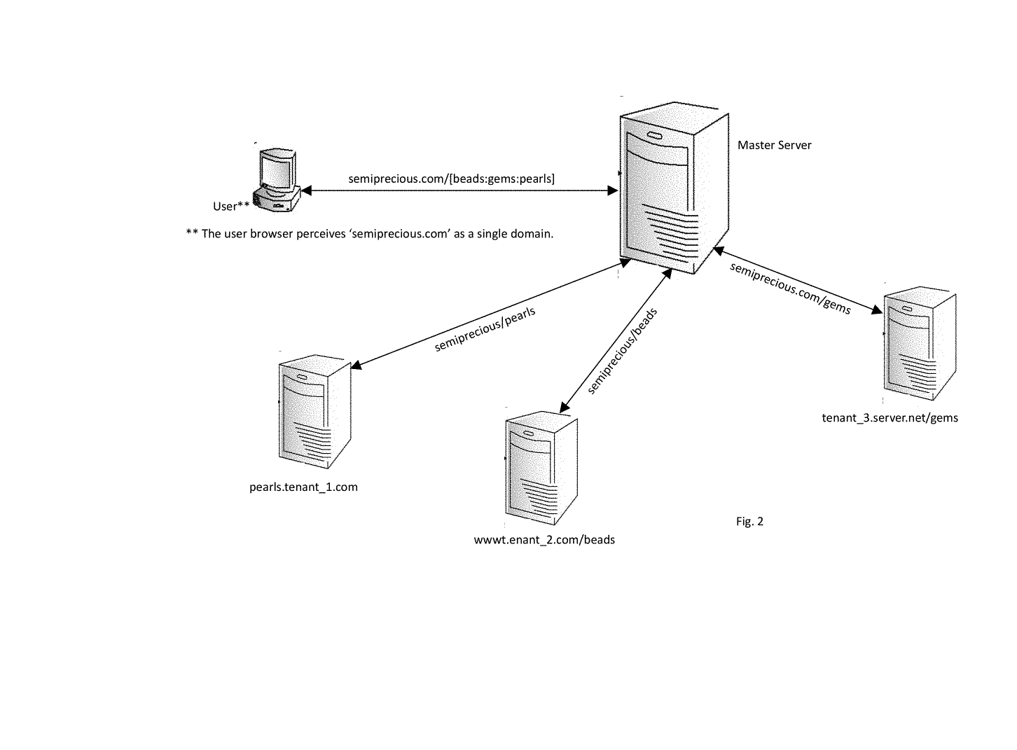

Request piped via Master Server: One alternate approach to facilitating delivery of content from a Tenant Server is to use reverse proxy (a function embodied in normal webservers, e.g., the Apache server) to fetch the content for the requested page from the Tenant Server(s) as shown in FIG. 2. In this embodiment, ALL of the specific pages (/gems, /pears, /beads) are hosted in the Tenant Servers belonging to different Tenants. To the Browsers, these pages are displayed under the original domain name (in this case semiprecious.com) and the page is displayed as semiprecious.com/pearl (or beads, or gems). In this approach, the page is always linked to the original domain but gets all new content from the respective Tenant Servers. Both original and the page under one domain get quid pro quo search benefits: the page (/pearls, /beads, /gems) gets it because it is linked to semiprecious.com; and the original domain gets it from vested Tenants helping its search ranking. One serious problem with this approach is that the Master Server has no visibility of the content delivered by the Tenant Server(s), since that content is generally automatically forwarded “as is”. Although known server plug-ins are available for filtering (actually, rewriting) the content, it is not generally considered safe to rely on such tools due to the large number of ways that undesirable content, e.g., malware, pornography, offensive content and the like, may be embedded in the delivered content.

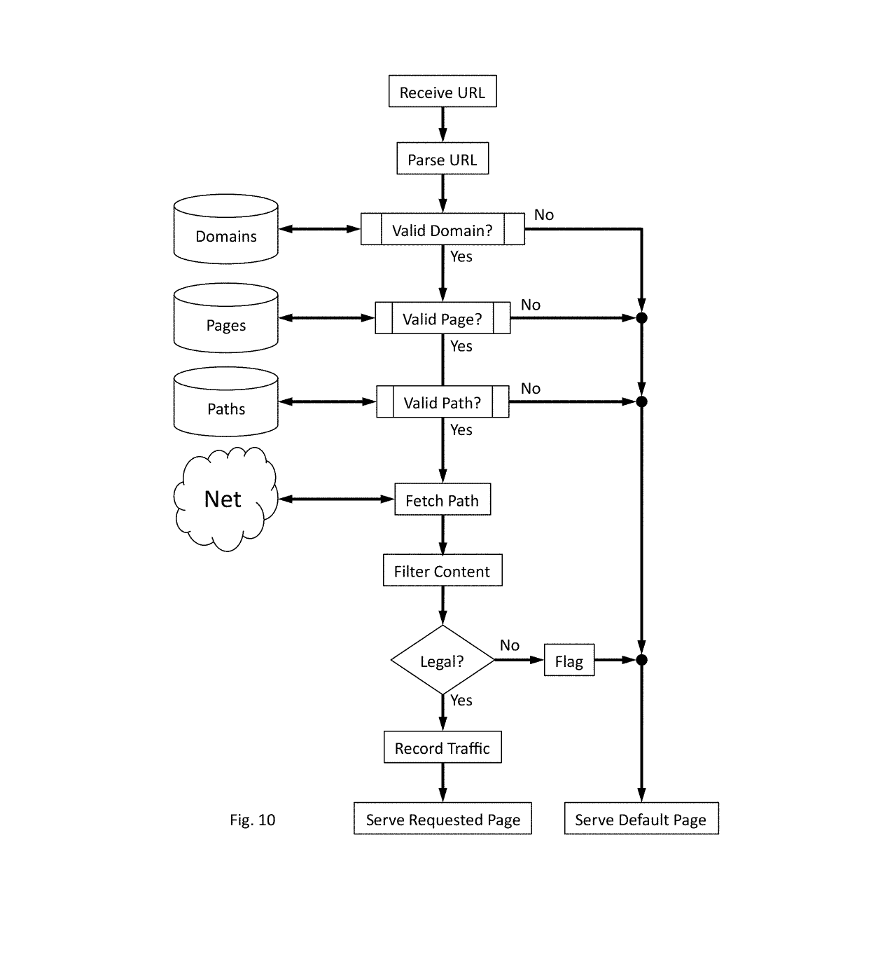

Content relayed by Master Server before delivery: An alternate approach, illustrated in FIG. 10, is to allow the Master Server to itself fetch the requested content from the Tenant Server(s) and, before forwarding to the requesting Browser, to apply one or more special-purpose filters to that content. For example, using a tool such as PHP, the Master Server can easily search for keywords, scan embedded images, detect embedded executable files, and the like, and take remedial actions as deemed appropriate and in conformance with the legal framework. In a UNIX environment, one utility commonly available to facilitate content fetching from the Tenant Server is cURL. Although this “man-in-the-middle” approach imposes additional computational burden on the host server, it offers the advantage of direct monitoring and control of content being delivered via the Master Server. In this respect, this approach tends to protect the reputation of ALL Owners and Tenants; in particular, it tends to detect undesirable Tenants relatively early, before significant damage can be done to the reputation (and, potentially, the SEO) of the entire domain including all of the Tenants.

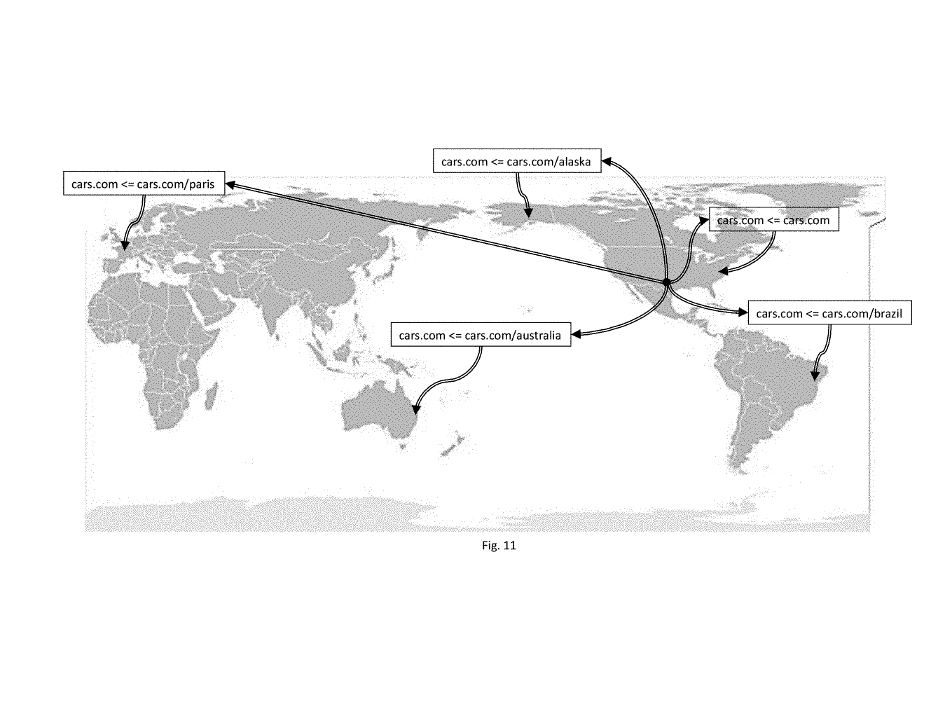

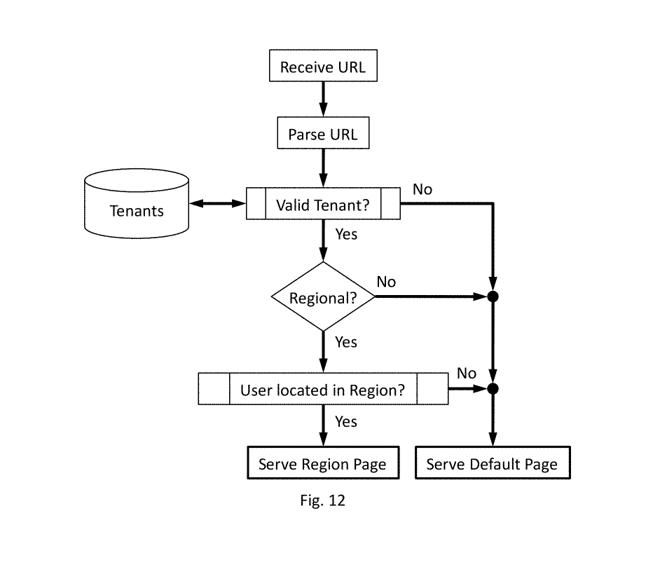

Content delivered by Master Server by Region: As illustrated in FIG. 11, we anticipate that, with some FQDNs, the Owner and Tenants will desire to establish Sections based on geographical regions. Thus, for example, a highly-desirable domain name such as “cars.com” may be partitioned into regions of any desired extent: a city, e.g., “cars.com/paris”; a state or province within a country, e.g., “cars.com/alaska”; a whole country, e.g., “cars.com/brazil”; or an entire continent, e.g., “cars.com/australia”. However, if desired, our system may be adapted, as illustrated in FIG. 12, to allow a User to simply enter the absolute domain name, i.e., “cars.com”, and, in response, our Master Server will initiate delivery of content specific to the User's geographical region. In general, known device location technology is not always successful in accurately identifying a given User's geographical location, although, with respect to some modern mobile devices, the integrated Global Positioning System (“GPS”) technology is usually successful. However, even in the event that our system is indeed able accurately to locate a User within the correct region, it is possible that the User desires to access a specific Section other than the local Section. Accordingly, we prefer that our Master Server serve a regional page adapted to allow the User to quickly access any of the other Sections associated with the desired domain name. For example, the initial splash page may display a prominent notice to the User that s/he has been connected to the local Section, but also include a drop-down selector having links to all of the Sections of the domain name. If enabled by the User, our Master Server may drop a cookie into the User's Browser to remember the most recent choice expressed by the User. Thus, our regionalization process tends to minimize the effort required for the User initially to access the most-likely-desired Section, and, thereafter, to return to that Section.

Although we have described our invention in the context of particular embodiments, one of ordinary skill in this art will readily realize that many modifications may be made in such embodiments to adapt either to specific implementations.

Thus it is apparent that we have provided an improved method and apparatus for providing a user-friendly mechanism for querying, reserving and establishing Tenantship of all registered Sections, thus enabling trading and monetization of Sections. Further, we submit that our method and apparatus provides performance generally superior to the best prior art techniques.

1. (canceled)

2. (canceled)

3. (canceled)

4. (canceled)

5. (canceled)

6. (canceled)

7. A method of registering geographical sections of a fully qualified domain name, wherein each geographical section comprises a respective domain name combined with one of a plurality of domain name modifiers, each domain name modifier representing a respective geographical region of the world, the method comprising:
[1] a geographical section registration process adapted to create and maintain a geographical section register;
[2] a listing process adapted to allow an owner of the domain name to list in the geographical section register a geographical section of the domain name available for tenantship;
[3] a reservation process adapted to allow a prospective tenant to reserve in the geographical section register a selected listed geographical section;
[4] a registration process adapted to allow the owner to register in the geographical section register a tenantship to the reserved geographical section for the benefit of the tenant; and
[5] a content delivery process adapted to:
[5.1] identify a geographical region of the world in which an accessing browser is located; and
[5.2] allow the tenant to source content for the registered geographical section as a function of the identified geographic region.

8. The method of claim 7, wherein step [2] is further characterized as:
[2] a listing process adapted to allow an owner of the domain name to list in the geographical section register a plurality of geographical sections of the domain name available for tenantship, each in accordance with a selected one of a plurality of forms of tenantship.

9. The method of claim 8, wherein step [3] is further characterized as:
[3] a reservation process adapted to allow a prospective tenant to reserve in the geographical section register a selected plurality of listed geographical sections, each in accordance with the respective form of tenantship selected by the owner.

10. The method of claim 7, wherein step [4] is further characterized as comprising:
[4.1] a legal framework adapted to facilitate negotiation between the owner and the tenant of terms and conditions of tenantship to the reserved geographical section; and
[4.2] a registration process adapted to allow the owner to register in the geographical section register the reserved geographical section as being encumbered by the tenantship for the benefit of the tenant.

11. The method of claim 7, wherein step [5] is further characterized as:
[5] a content delivery process adapted to:
[5.1] identify a geographical region of the world in which an accessing browser is located; and
[5.2] allow the tenant directly to source content for the registered geographical section as a function of the identified geographic region.

12. The method of claim 7, wherein step [5.2] is further characterized as:
[5.2.1] a content generation process adapted to allow the tenant to generate content for the registered geographical section as a function of the identified geographic region; and
[5.2.2] a content redirection process adapted to source the generated content directly from the tenant to a browser under control of a host.

13. The method of claim 7, wherein step [5] is further characterized as:
[5] a content delivery process adapted to:
[5.1] identify a geographical region of the world in which an accessing browser is located; and
[5.2] allow the tenant indirectly to source content for the registered geographical section as a function of the identified geographic region.

14. The method of claim 7, wherein step [5.2] is further characterized as:
[5.2.1] a content generation process adapted to allow the tenant to generate content for the registered geographical section as a function of the identified geographic region; and
[5.2.2] a content proxy process adapted to source the generated content from the tenant to a browser via a host.

15. The method of claim 7, wherein step [5.2] is further characterized as:
[5.2.1] a content generation process adapted to allow the tenant to generate content for the registered geographical section as a function of the identified geographic region;
[5.2.2] a content retrieval process adapted to retrieve the generated content from the tenant to a host; and
[5.2.3] a content delivery process to source the retrieved content from the host to a browser.

16. The method of claim 15, wherein step [5.2.2] is further characterized as:
[5.2.2.1] a content retrieval process adapted to retrieve the generated content from the tenant to a host; and
[5.2.2.2] a content filter process adapted to apply a predetermined filter to the retrieved content.

17. (canceled)

18. The method of claim 7, further comprising:
[6] a solicitation process adapted to solicit the owner of a domain name to list an unlisted geographical section of that domain name.

19. A web server facility configured to perform the method of any preceding claim.

20. A non-transitory computer readable medium including executable instructions which, when executed in a processing system, causes the processing system to perform the steps of a method according to any one of claims 7 to 16 and 18.
